(19) United States
(12) Patent Application Publication
(10) Pub. No.: US 2003/0191817 A1
(43) Pub. Date: Oct. 9, 2003

(54) Method and system for dynamic language display in network-based applications

(76) Inventor: Justin Fidler, Washington, DC (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 09/773,932

(22) Filed: Feb. 2, 2001

Related U.S. Application Data
(60) Provisional application No. 60/179,740, filed on Feb. 2, 2000.

(51) Int. Cl. G06F 15/16

(52) U.S. Cl. 709/219

(57) ABSTRACT

A method and system for efficiently and quickly displaying network web page information and performing cross-network functions, such as applets, in multiple languages, in which web page code strings to be transmitted are dynamically composed to include textual information in a preselected language. As the web page information is transmitted to the user for display, the information is dynamically built using template information common to all users, regardless of language, and appropriately inserted information for text in the language selected. The proper language text insertion occurs by virtue of special tags within the template for the page selected. A previously determined language selection, which occurs by user input or automatic determination, results in the text file for the selected language being loaded into the server memory supporting the web page to be transmitted. The processor at the server inserts the parsed portions of the textual information at appropriate locations within the web page code prior to the code being transmitted to the user's browser for display. As a result, multiple languages are supported in a manner that is efficient for transmission to the user and that simplifies and reduces redundancy and error when code modification is necessary. Similarly, with cross network applications, such as applets, network functions are created to include proper language text dynamically from parameters for the underlying web page template for transmission for functions to be performed via the user's browser.

### FIELD OF THE INVENTION

This invention relates to a method and system for efficiently and quickly displaying network web page information and performing operations across a network in multiple languages, and in particular to a method and system for efficiently transmitting web page code strings dynamically composed during transmission to include textual information in a preselected language and for efficiently performing cross network functions via applets in multiple languages.

### BACKGROUND

A problem with efficiency for Internet and other network web pages exists relating to the fact that two concepts or two abstract portions must be addressed on a web page. One portion is the logic, which governs how the page works, and a second portion is the information displayed. For example, for a simple application for a given web page, the logic portion may indicate, for example, that on Sundays a picture of a sun is to be displayed, and on Mondays, a picture of a scene containing rainfall is to be displayed. For most web page applications, the logic portion, which is highly complex, must address such a display using code containing text and graphics, along with logic linked to input or read information, such as the system clock.

Further, typical web pages contain displayed language content that must be linked or tied to the logic portion. However, tying the language content to the logic portion presents a problem in many applications. For example, the logic may indicate that on December 25, the web page is to display “Merry Christmas.” The logic therefore generally is “if day equals December 25, print this statement: ‘Merry Christmas.’” A problem, however, is that “Merry Christmas” is in English, and there typically is no simple and efficient method for displaying the same information in another language, if the user so prefers.

In one type of prior art attempt to solve this problem, a different logic set contained within a separate code file is used for each language. For example, if the system supports two different languages, two complete files of logic and text information for the web page are maintained. In operation, in retrieving a web page, for example, only one of the maintained file copies is loaded, depending on the language selection input received. Besides being cumbersome and inefficient, this approach results in bad programming structure because multiple code modifications must take place for each file each time a change is needed.

In another prior art attempt to solve this problem, a single code file is maintained for all of the different languages supported, with complete sets of textual information maintained within the file for each language. With this prior art solution, problems particularly with speed of operation arise each time a language display occurs, because the system logic must search through the many phrases to find the correct one for the selected language. In addition, a much larger file must be maintained and loaded during each retrieval because a greater amount of information must be repeated and stored to address all of the languages included. As a result, the web page may include thousands of lines of code, containing every possible phrase in every possible language being supported, most of which is not used in any given web page transmittal, and which greatly slows processing.

Similarly, applets, such as Java™ applets, or other software functioning across the network must typically be reproduced for each language a user is able to select. For example, labels for functioning buttons on a web page that operate through an applet require separate applets for each language: applets to allow operations for a French user are created to display French text for the buttons; English users require applets having English text for buttons; and where many language options are required, a large number of applets must be created or applets become very large so as to incorporate many languages with the same functions.

There remains a need to provide an efficient method and system for allowing multiple language text and logic linking for web page display.

### SUMMARY OF THE INVENTION

The present invention overcomes the problems of the prior art by providing a method and system for efficiently and quickly displaying network web page information and performing cross-network functions, such as applets, in multiple languages, in which web page code strings to be transmitted are dynamically composed to include textual information in a preselected language. In an embodiment of the present invention, as the web page information is transmitted to the user for display, the information is dynamically built using template information common to all users, regardless of language, and appropriately inserted information for text in the language selected.

In an embodiment of the present invention, the proper language text insertion occurs by virtue of special tags within the template for the page selected. A previously determined language selection, which occurs by user input or automatic determination, results in the text file for the selected language being loaded into the server memory supporting the web page to be transmitted. The processor at the server inserts the parsed portions of the textual information at appropriate locations within the web page code prior to the code being transmitted to the user's browser for display. As a result, multiple languages are supported in a manner that is efficient for transmission to the user and that simplifies and reduces redundancy and error when code modification is necessary.

Similarly, in another embodiment of the present invention relating to operations performed in conjunction with cross network applications, such as applets, network functions are created to include preferred language text inserted dynamically from parameters for the underlying web page template for performance via the user's browser.

To achieve the stated and other advantages of the present invention, as embodied and described below, the invention includes a method for dynamically and efficiently composing network web pages in a preferred language for the user, for transmission from a server having a server memory to a user terminal on a network, the method comprising: the server receiving a request for a web page from the user terminal; identifying the preferred user language; composing the web page using the preferred user language and an uncomposed web page; wherein the uncomposed web page comprises logic and layout information; wherein the uncomposed web page includes at least one tag for dynamically inserting textual information retrieved from a user language text file; wherein the textual information is retrieved by loading a user language text file into the server memory; and wherein composing the web page includes parsing the user language text file and inserting the parsed user language text file into the uncomposed web page logic and layout information; and transmitting the composed web page to the user terminal.

To achieve the stated and other advantages of the present invention, as embodied and described below, the invention further includes a method for dynamically and efficiently composing network web pages in a preferred language for the user, for transmission from a server having a server memory to a user terminal on a network, the method comprising: the server receiving a request for a web page from the user terminal; identifying the preferred user language; providing a web page template for the web page, the web page template including logic and layout information and at least one tag for dynamically inserting textual information retrieved from a user language text file; loading a user language text file into the server memory; composing the web page, wherein composing includes parsing the user language text file and inserting the parsed user language text file into the uncomposed web page logic and layout information; and transmitting the composed web page to the user terminal.

To achieve the stated and other advantages of the present invention, as embodied and described below, the invention further includes a method for dynamically performing functions for a web page transmitted from a server to a terminal, the functions being performed using text in a user preferred language, the method comprising: the server receiving a request for the web page from the user terminal, the web page including at least one applet, the at least one applet including displayed text information; identifying the preferred user language; loading a user language text file into the server memory; composing the web page, wherein composing includes providing parameters containing applet text in the preferred user language; retrieving the applet text in the preferred user language via the parameters; and inserting the retrieved applet text into the at least one applet as the displayed text information.

To achieve the stated and other advantages of the present invention, as embodied and described below, the invention further includes a system for dynamically and efficiently composing a network web page for transmission to a user using text in a user preferred language, the system comprising: a server on a network having an accessible repository for storing the multimedia information; and at least one terminal coupled to the server via the network for providing user access to information supplied by the server; wherein a web page request is received by the server; wherein a user language is identified; wherein a web page is composed using the preferred user language and an uncomposed web page; wherein the uncomposed web page comprises logic and layout information; wherein the uncomposed web page includes at least one tag for dynamically inserting textual information retrieved from a user language text file; wherein the textual information is retrieved by loading a user language text file into the server memory; and wherein composing the web page includes parsing the user language text file and inserting the parsed user language text file into the uncomposed web page logic and layout information; and wherein the composed web page is transmitted to the user terminal.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 depicts an overview diagram of the components and users in accordance with an embodiment of the present invention;

FIG. 2A is a block diagram of the server elements of an embodiment of the present invention;

FIG. 2B shows a block diagram of repository elements in accordance with an embodiment of the present invention;

FIGS. 3A-3B present a flow diagram of an example web page retrieval by a user and dynamic composition of the web page with user language preferred text in accordance with an embodiment of the present invention; and

FIG. 4 is a flow diagram of applet user of web page information with user language preferred text in accordance with an embodiment of the present invention.

### DETAILED DESCRIPTION

The present invention operates in typical network environments that include one or more servers coupled, such as by wired, wireless, or fiberoptic links, to one or more terminals. One or more users access web information from the servers via the terminals and couplings. Web information is viewed using, for example, a web browser that displays the information to each user. The displayed web information is composed for display as web pages, typically via lines of text code.

The present invention comprises a method and system for efficiently and quickly displaying network web page information and performing cross-network functions, such as applets, in multiple languages, in which web page code strings to be transmitted are dynamically composed to include textual information in a preselected language. In an embodiment of the present invention, as the web page information is transmitted to the user for display, the information is dynamically built using template information common to all users, regardless of language, and appropriately inserted information for text in the language selected.

In an embodiment of the present invention, the proper language text insertion occurs by virtue of special tags within the template for the page selected. A previously determined language selection, which occurs by user input or automatic determination, results in the text file for the selected language being loaded into the server memory supporting the web page to be transmitted. The processor at the server inserts the parsed portions of the textual information at appropriate locations within the web page code prior to the code being transmitted to the user's browser for display. As a result, multiple languages are supported in a manner that is efficient for transmission to the user and that simplifies and reduces redundancy and error in code modification.

The present invention includes a method and system for tracking, session-wide, the user's language preference, using standard National Language System (NLS) format labels. In accordance with an embodiment of the present invention, when a web page is rendered on the server, the page dynamically includes a proper language variable set. Also included are any display data that are tied to dates, which are rendered automatically through database calls, since this display data are dynamic data that cannot be stored in a language variable set.

The present invention provides a method and system for providing logic in one portion of each web page and the text to be displayed in another portion, such that the language may be extracted “on the fly” during web page rendering for placement in a single location within the displayed web page. For example, if the web page logic determines that “if today is December 25, print the message for Merry Christmas,” then the present invention, on the fly, queries a second area to determine the user's language preference, and retrieves and displays the inserted proper statement for that language. Thus, the phrase “Feliz Navidad,” is retrieved if the user prefers Spanish.

In the prior art for the “Merry Christmas” example, the server processes a line that tells the browser to print the phrase if the condition of the date is met. If the condition is not met, the line is not printed, and the next line of code is processed. All the lines of code for every condition anticipated are included in the transmitted code, but each event, such as printed information, varies depending on the conditions met. For multiple languages included, a line of code is included, for example, for each phrase in each language. As a result, many nearly identical lines of code must be included, each containing a condition for determining the date, determining the language used, and then providing the proper phrase for that language, and if all conditions are met, the phrase is displayed in that language.

In contrast to the prior art, the present invention includes within the web page layout the logic in one area of the code, and the text to be loaded in another area. Thus, for example, the words “Merry Christmas” are no where to be found in the initial “template” for the web page to be transmitted. Instead when the code reaches the portion of the template for the web page in which this text is to be displayed, the logic determines that a text string is needed and queries the system for a language selection. If the user's preference is Spanish, for example, the Spanish file is loaded into the memory and the proper line of text is parsed from the loaded file. Since the web page of the present invention is loaded dynamically, during the process of transmitting the page for display, the proper language file is loaded, as appropriate, and integrated into the transmitted code. As a result, only information from the file for the selected language is included, and no additional language code lines are transmitted. Multiple languages are therefore supported in a much faster and more efficient manner than the prior art.

Functionally, the code provides that the very first line of each business logic page tells the system to load the text set in the user's current language, which remains loaded into memory. As each phrase or other portion of text is needed, that particular piece of text is pulled from the loaded memory to dynamically create and transmit the completed web page.

In one embodiment of the present invention, textual information is stored at the server in a repository, such as or including a database, in a separate file from logic and layout information, which is included in a web page template. The language text file is read into the server memory based on the language selection made. In an embodiment of the present invention, the architecture for the web pages is written in a mark up language, such as ColdFusion®, by Allaire Corporation of Cambridge, Mass. ColdFusion® is a commercially available product that provides a development environment for creation of web pages that include dynamic data elements.

ColdFusion® is a templated web page building language that supplements a common web building language called Hypertext Markup Language (HTML). HTML includes a feature called tags, which are embedded characters containing coded instructions. ColdFusion® adds additional tags to HTML, which are specific to ColdFusion®. These ColdFusion® tags link the HTML code to commands that are performed in ColdFusion®. In an embodiment of the present invention, the ColdFusion® tag commands cause the server to proceed through the HTML file, identify the language for the user, identify locations for text in the language selected to be inserted, insert the text in the proper language as required, and cause the processed and completed web page with inserted text to be forwarded to the user's browser.

In an embodiment of the present invention, the user's language selection is determined via a number of factors or triggers. If the user is identified as having previously accessed the web page and as having an associated language assigned to that user, the associated language is used. If the user selected a default language during login or registration, this default language is selected for the user. Absent the system being able to determine an assigned language for the user, the system prompts the user to select a default language. For example, in one embodiment, a screen prompt appears for the user in multiple languages requesting the user to select a language for system use.

In an embodiment of the present invention, triggering of use of a particular language operates through the use of a variable that is linked to an NLS format, as is known in the art. NLS is a convention for naming language, similar to International Standards Organization (ISO) codes for countries, in which a two letter code is used for each language. These codes are used to reduce confusion.

An example of on the fly insertion of textual information in a selected language for a transmitted web page will now be described. In this example, the selected language for the user is Spanish. A first web page to be transmitted is called “Start.cfm.” The “Start.cfm” page produced in, for example, ColdFusion®, includes three portions: 1) the logic for page operations (e.g., determining that today's date is December 25); 2) the layout for the web page (e.g., the location of text and graphics; the relative placement of each piece of the web page); and 3) the textual and other content of the web page.

A line of code or tag for this example page indicates to the processor to include the file for the selected language (Spanish) for the inserts for the “Start.cfm” page. A file in Spanish for insertion in the “Start.cfm” web page is then retrieved and loaded into the processor memory, such as memory on a server.

The approach of this embodiment to web page creation and transmittal has a number of benefits. For example, because only the textual information typically must be replicated to provide the web page in multiple languages, only the language text files in ColdFusion® need to be modified when a change is made to text. In contrast to the prior art, in which all of the logic, layout, and textual information must be repeated for each language, the logic and layout portions of the web page to be transmitted are unaffected with a textual change in the present invention.

Another aspect of the present invention is use of ColdFusion® or similar tag function insert technology in conjunction with use of cross network applications and functions, such as Java™ applets. In an embodiment of the present invention, all code strings that are also passed as a result of tags in the logic and layout template incorporating textual information are passed, for example, to the Java™ applet operating in conjunction with functions on the web page.

In an embodiment of the present invention, the Java™ applet retrieves the proper text insert, as needed, from, for example, parameters associated with the ColdFusion® created page, and places the text for display within the web page. The retrieval of text in this embodiment occurs using a plugin text reference from the ColdFusion® created page, and the text is inserted regardless of the language. As a result, any applet associated with the web page obtains the same benefits of reduced size and reduced errors resulting from code modifications since all text information is maintained separately from the applet functional code.

Thus, for an example button function within a web page operating by virtue of a Java™ applet, button labels for these buttons are provided using the same loaded user preferred language file by providing this information to the applet. A button that functions via a Java™ applet and is labeled “quit” in English is labeled, for example, quitter in French.

The insertion of text within the applet occurs as a result of basic applet functions. Generally, web pages are written in HTML and include tags. One of the tags is an applet tag. Other tags include parameter tags. In an embodiment of the present invention, for text input, ColdFusion® loads the parameter tags, which are referenced by number, with the code strings for text of the language preferred by the user. The applet begins loading as a result of the web page being loaded into memory and is able to reference any of the parameters that were on the HTML page. The parameters referenced by the applet include, for example, text in the language of the user, which is loaded as part of the applet functions. For example, a “quit” label in English is loaded for a quit button functioning via the applet.

With Java™, which is an object oriented language, each applet receives parameters, which are used to perform functions. When a ColdFusion® page, with which the Java™ applet is associated, is launched, parameters are transmitted from the ColdFusion® page to the Java™ applet. For text inserts in the Java™ applet, the parameters are language strings in the user preference language. The applet receives only text in the user preference language, which enhances speed and efficiency of the applet, while reducing use of resources, such as processor memory. In an embodiment of the present invention, the strings are referenced using numbers, rather than names, to further reduce use of resources, since numbers are shorter to represent than names in Java™.

References will now be made in detail to embodiments of the present invention, examples of which are illustrated in the accompanying drawings.

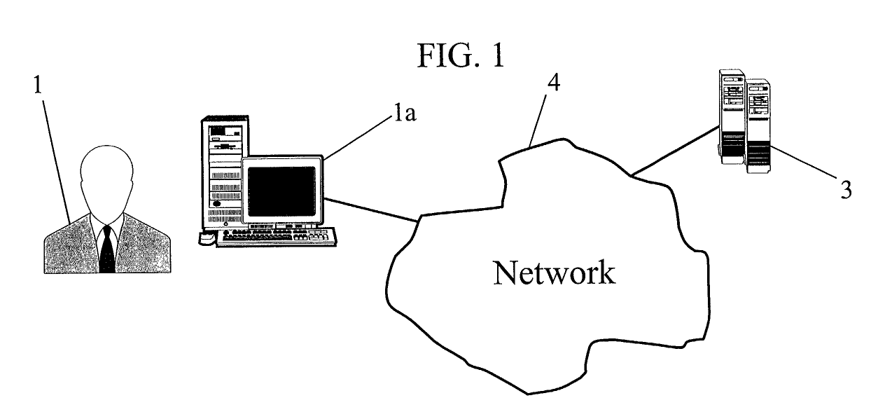

FIG. 1 depicts an overview diagram of the components and users in accordance with an embodiment of the present invention. As shown in FIG. 1, a user 1 at a terminal 1a, such as a personal computer, minicomputer, microcomputer, mainframe computer, telephone, or other device having a display and capability for providing browsing on a network, accesses a server 3, such as a personal computer, minicomputer, microcomputer, mainframe computer, or other device having a processor and a database or coupling to a database for storing and accessing information, via a network 4, such as the Internet or an intranet, and couplings 3, 5. The couplings 3, 5 include, for example, wired, wireless, or fiberoptic communication links. In accordance with an embodiment of the present invention, the user 1 retrieves a web page from the server 3 via the terminal 1a and the network 4. The web page includes tags for providing text in the preferred language of the user 1. For functions performed in conjunction with the web page, an applet, such as a Java™ applet operates across the server 3, the network 4, and the terminal 1a.

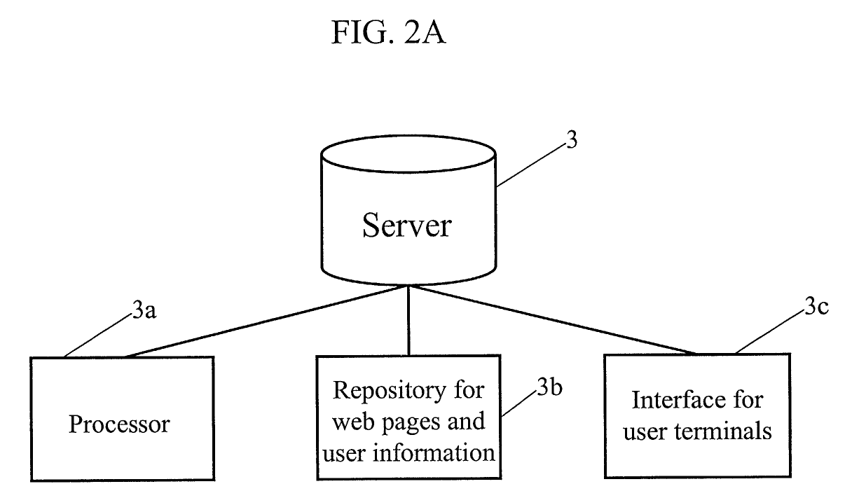

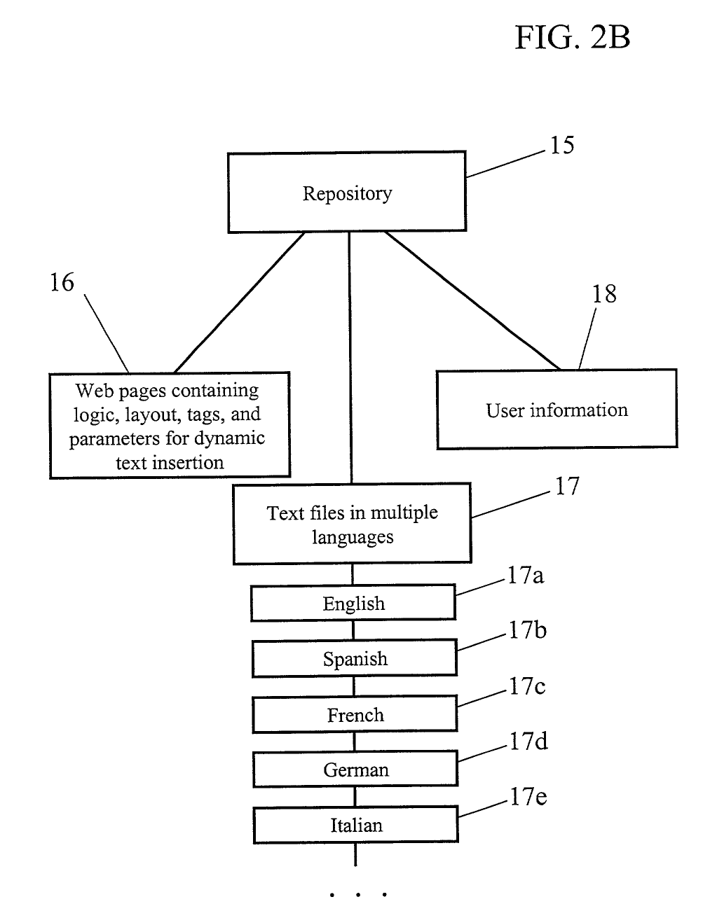

FIG. 2A is a block diagram of the server elements of an embodiment of the present invention. As shown in FIG. 2A, the server 3 includes a processor 3a used for providing such functions as transmitting information to user terminals, receiving password information from user terminals, and verifying identity and other information relating to each user and user terminal. The server 3 also includes a repository for web pages and user information 3b, which is organized, for example, by user identifier. Also included in the server is an interface for interfacing with user terminals 3c, such as an Internet or intranet connection device and associated software and hardware.

FIG. 2B shows a block diagram of repository elements in accordance with an embodiment of the present invention. As shown in FIG. 2B, the repository 15, which optionally is composed of or includes one or more databases, houses web pages, containing logic, layout, tags, and parameters for dynamic text insertion 16, text files in multiple languages 17, and user information 18, such as user language preferences and user identifiers. The text files 17 include files in each supported language, such as English 17a, Spanish 17b, French 17c, German 17d, and Italian 17e.

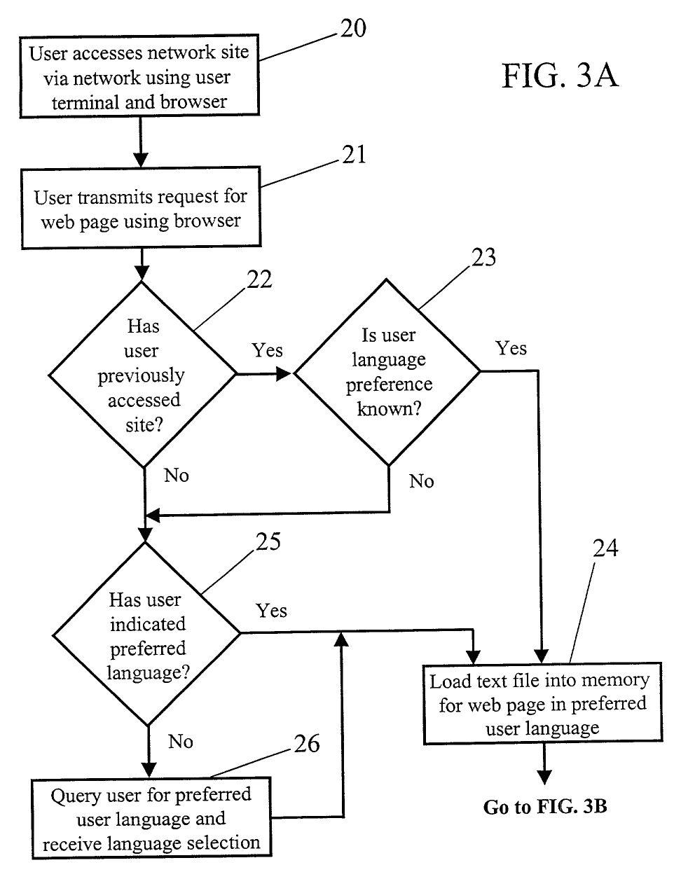

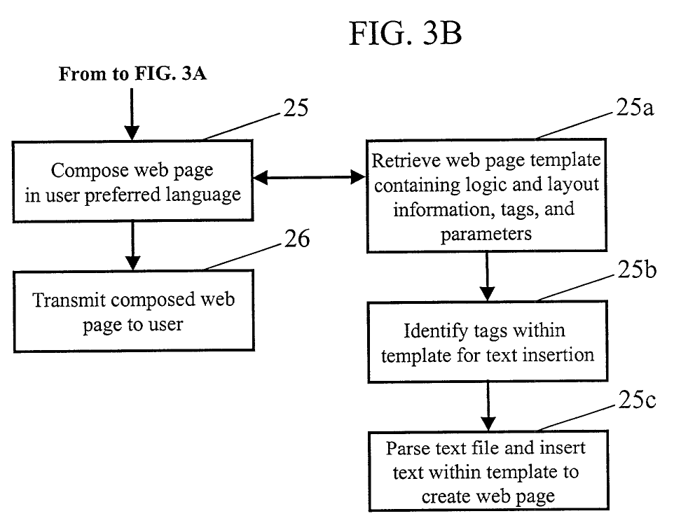

FIGS. 3A-3B present a flow diagram of an example web page retrieval by a user and dynamic composition of the web page with user language preferred text in accordance with an embodiment of the present invention. As shown in FIG. 3A, the user accesses the network site via a network, such as the Internet, using a user terminal and a browser 20. The user transmits a request of a web page using the browser 21. A determination is then made as to whether the user previously accessed the site 22. If the user has previously accessed the site, a determination is made as to whether the user language preference is known 23, such as by previous input of preferred language by the user. Determination of previous access is made, for example, by assigning a user identifier, such as a user name, and optionally a password to the user, with verification of the password occurring prior to web page retrieval and transmittal being enabled. If the language preference of the user is known, the text file in the user preferred language is loaded into memory 24. If the user has not previously accessed the site, or if the user has previously accessed the site, but the user language preference is unknown, a determination is made as to whether the user has indicated a preferred language 25, such as by requesting the page in a particular language. If the user has indicated a preferred language, the text file in the user preferred language text file is loaded into memory 24. Otherwise, the user is queried for a preferred user language, and the preferred language selection is received 26, after which the preferred language text file is loaded into memory 24.

As shown in FIG. 3B, the web page is then composed in the user preferred language 25. Composition of the web page includes retrieving the web page template, containing logic and layout information, tags, and parameters, identifying tags within the template for text insertion 25b, and parsing the text file in the user preferred language for insertion of text within the template to create the web page 25c. The composed web page is then transmitted to the user 26.

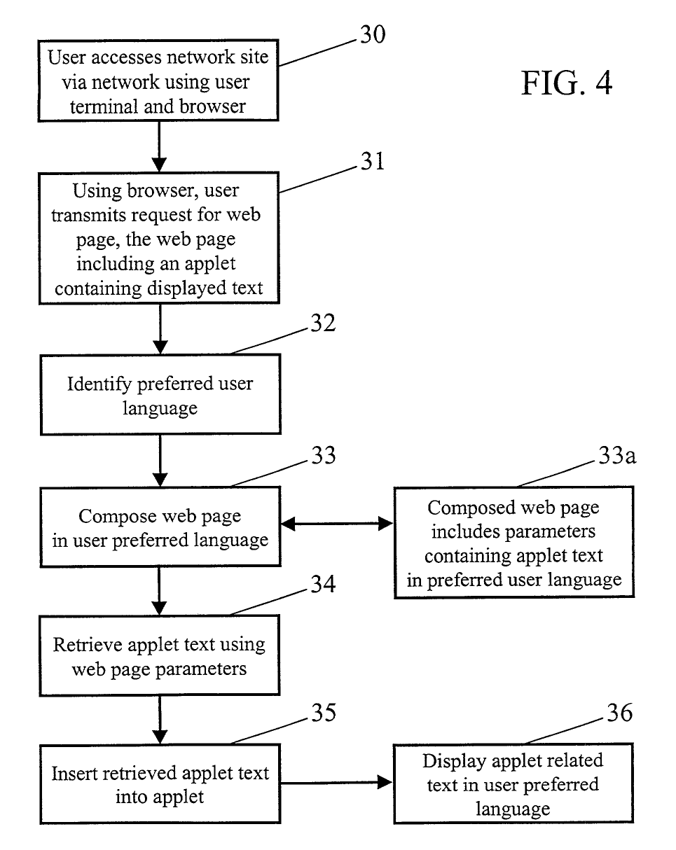

FIG. 4 is a flow diagram of applet user of web page information with user language preferred text in accordance with an embodiment of the present invention. As shown in FIG. 4, the user accesses a network site via a network, such as a web site on the Internet, using a terminal and browser 30. Using the browser, the user transmits a request for a web page, the web page including one or more applets that contain displayed text 31. A preferred user language is identified 32. The web page is composed using the user preferred language 33, the composed web page including parameters containing applet text in the preferred user language 33a. The applet text is retrieved using the web page parameters 34, such as by use of tags in the applet. The retrieved text is inserted into the applet 35, and the applet related text is thereby displayed in the user preferred language 36.

Example embodiments of the present invention have now been described in accordance with the above advantages. It will be appreciated that these examples are merely illustrative of the invention. Many variations and modifications will be apparent to those skilled in the art.

1. A method for dynamically and efficiently composing network web pages in a preferred language for the user, for transmission from a server having a server memory to a user terminal on a network, the method comprising:
the server receiving a request for a web page from the user terminal;
identifying the preferred user language;
composing the web page using the preferred user language and an uncomposed web page; wherein the uncomposed web page comprises logic and layout information; wherein the uncomposed web page includes at least one tag for dynamically inserting textual information retrieved from a user language text file; wherein the textual information is retrieved by loading a user language text file into the server memory; and wherein composing the web page includes parsing the user language text file and inserting the parsed user language text file into the uncomposed web page logic and layout information; and
transmitting the composed web page to the user terminal.

2. A method for dynamically and efficiently composing network web pages in a preferred language for the user, for transmission from a server having a server memory to a user terminal on a network, the method comprising:
the server receiving a request for a web page from the user terminal;
identifying the preferred user language;
providing a web page template for the web page, the web page template including logic and layout information and at least one tag for dynamically inserting textual information retrieved from a user language text file;
loading a user language text file into the server memory;
composing the web page, wherein composing includes parsing the user language text file and inserting the parsed user language text file into the uncomposed web page logic and layout information; and
transmitting the composed web page to the user terminal.

3. The method of claim 2, wherein the web page is composed in ColdFusion®.

4. The method of claim 2, wherein the web page is composed in Hypertext Markup Language.

4. The method of claim 2, wherein identifying the preferred user language includes:
prompting the user for a selection of a language; and
receiving a user selection of a language.

5. The method of claim 2, further comprising:
assigning a user identifier to the user.

6. The method of claim 5, wherein the user identifier includes a user name and a password, the password being associated with the user name, the method further comprising:
prompting the user to provide the user name and a password input;
receiving the password input;
comparing the password input to the password; and
if the password input matches the password, enabling transmitting of the web page to the user terminal.

7. The method of claim 5, further comprising:
determining whether the user has a previously assigned user identifier.

8. The method of claim 5, further comprising:
if the user has a previously assigned user identifier, determining if the user has a previously selected user language preference.

9. The method of claim 2, wherein the preferred user language includes one from a group consisting of English, French, German, Spanish, and Italian.

10. The method of claim 2, wherein the network comprises the Internet.

11. A method for dynamically performing functions for a web page transmitted from a server to a terminal, the functions being performed using text in a user preferred language, the method comprising:
the server receiving a request for the web page from the user terminal, the web page including at least one applet, the at least one applet including displayed text information;
identifying the preferred user language;
loading a user language text file into the server memory;
composing the web page, wherein composing includes providing parameters containing applet text in the preferred user language;
retrieving the applet text in the preferred user language via the parameters; and inserting the retrieved applet text into the at least one applet as the displayed text information.

12. The method of claim 11, wherein the at least one applet is composed in Java™.

13. A system for dynamically and efficiently composing a network web page for transmission to a user using text in a user preferred language, the system comprising:
a server on a network having an accessible repository for storing the multimedia information; and
at least one terminal coupled to the server via the network for providing user access to information supplied by the server;
wherein a web page request is received by the server;
wherein a user language is identified;
wherein a web page is composed using the preferred user language and an uncomposed web page; wherein the uncomposed web page comprises logic and layout information; wherein the uncomposed web page includes at least one tag for dynamically inserting textual information retrieved from a user language text file; wherein the textual information is retrieved by loading a user language text file into the server memory; and wherein composing the web page includes parsing the user language text file and inserting the parsed user language text file into the uncomposed web page logic and layout information; and
wherein the composed web page is transmitted to the user terminal.

14. The system of claim 13, wherein the at least one terminal and the server are coupled via a coupling.

15. The system of claim 14, wherein the coupling comprises one from a group consisting of a wired connection, a wireless connection, and a fiberoptic connection.

16. The system of claim 13, wherein the at least one terminal comprises one selected from a group consisting of a personal computer, a minicomputer, a microcomputer, a main frame computer, and a telephone device.

17. The system of claim 13, wherein the server comprises one selected from a group consisting of a personal computer, a minicomputer, a microcomputer, and a main frame computer.

18. The system of claim 13, wherein the server comprises a storage device, the storage device including the accessible repository.

19. The system of claim 13, further comprising:
a repository server coupled to the server, the repository server comprising a storage device, wherein the storage device includes the accessible repository.

20. The system of claim 13, wherein the network is the Internet.

21. The system of claim 13, wherein the repository includes a database.

22. A system for dynamically and efficiently composing network web pages in a preferred language for the user, for transmission from a server having a server memory to a user terminal on a network, the system comprising:
means for the server receiving a request for a web page from the user terminal;
means for identifying the preferred user language;
means for providing a web page template for the web page, the web page template including logic and layout information and at least one tag having means for inserting dynamically textual information retrieved from a user language text file;
means for loading a user language text file into the server memory;
means for composing the web page, wherein the means for composing includes means for parsing the user language text file and means for inserting the parsed user language text file into the uncomposed web page logic and layout information; and
means for transmitting the composed web page to the user terminal.
